(19) United States
(12) Patent Application Publication
(10) Pub. No.: US 2012/0153222 A1
(43) Pub. Date: Jun. 21, 2012

(54) Container system for pasty compositions

(75) Inventor: Frank Kroeowski, Bardowick (DE)

(73) Assignee: Mankiewicz Gebr. Co. GmbH & Co. KG, Hamburg (DE)

(21) Appl. No.: 13/065,153

(22) Filed: Mar. 15, 2011

(30) Foreign Application Priority Data
Dec. 16, 2010 (DE) 10 2010 054 805.7

(51) Int. Cl. B65D 45/16; C09K 3/00

(52) U.S. Cl. 252/183.11; 220/324; 220/200

(57) ABSTRACT

A container system for pasty compositions includes one or more cylindrical hollow bodies each having a removable base plate and a removable lid. In particular, the container system includes two containers, each separately holding one of the components for the production of a two-component putty. The ratio of the dimensions of the two containers in terms of their capacity or their volume is equal to the ratio by weight or by volume in which the two components are used. Further, a method produces a curable putty using this container system in which the components of the composition are almost totally removed from the containers and are intermixed to form a homogeneous substance, which is then processed.

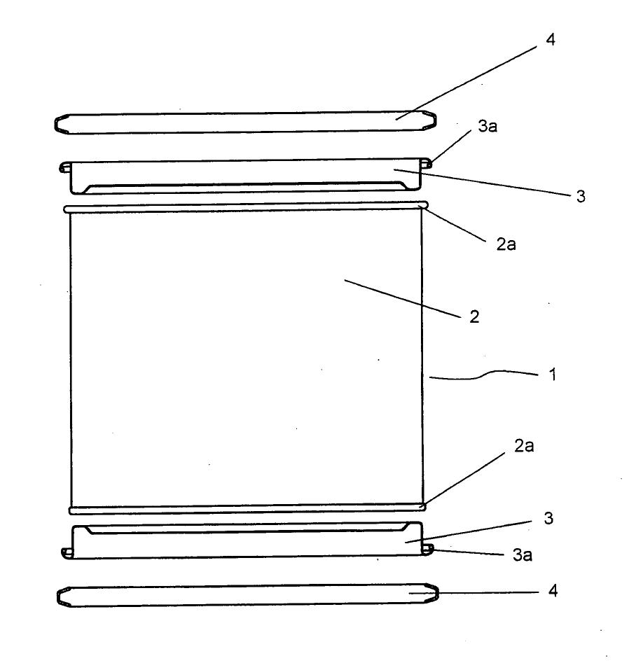

### CROSS REFERENCE TO RELATED APPLICATIONS

Applicant claims priority under 35 U.S.C. §119 of German Application No. 10 2010 054 805.7 filed Dec. 16, 2010, the disclosure of which is incorporated by reference.

### BACKGROUND OF THE INVENTION

1. Field of the Invention

The present invention relates to a container system for pasty compositions, more particularly for two-component putties, which container system exhibits improved transport and storage properties, and makes it possible to empty its contents in a simple manner.

2. Description of the Related Art

Generally, nautical vehicles are mainly coated with putties produced manually just before application. As a rule, the putties themselves comprise two components, a base component and a reactive component, these being used in a mixing ratio of, for example, 1:1 by volume. As is standard practice, the components are individually bottled by volume by the manufacturer in bucket-like plastic containers, sealed by means of a lid, and then dispatched.

The respective containers comprising the base component and the reactive component are then emptied by the user onto a mortar board. The two components are then mixed manually with a rectangular block of wood or a putty knife. It is usual to color the two components of the putty differently in order to know when the mixture is homogeneous on the basis of the uniformity of the mixed colors of the composition. The putty is then applied and cured.

For the purpose of emptying the components from conventional containers, the user removes the lid, turns the container upside down so that its top opening rests on the mortar board, and then waits for the composition, usually of a pasty nature, to flow from the container onto the board. However, it takes a considerable amount of time for the container to become empty, due to the very high viscosity of the composition. Alternatively, the container can rest with its edge on the mortar board, and its contents can be scraped out manually with a putty knife. These procedures are repeated for the containers holding the second component. Both methods suffer from the drawback, among others, that the containers cannot be emptied completely. There always remain residual amounts of the respective component in each container so that the mixing ratio predefined by the package size is altered in an unknown way due to this loss of material. However, putties react very sensitively to changes in the mixing ratio. As a rule, a putty mixed in the wrong mixing ratio will usually exhibit worsened product properties.

The plastic containers used are generally of a tapered shape, narrowing toward the base plate of the container. Usually, a snap-on lid is used that is simply pressed onto the rim of the container. However, conventional snap locks only secure the container from complete removal of the lid and not from rotational movement and twisting of the lid relatively to the bucket-shaped container. The fact that this lid is not tightly attached is a further disadvantage of conventional containers. The lid can easily slip as a result of external impact to the effect that the containers will no longer be hermetically sealed. Primarily during transportation of containers stacked one on top of the other, will the lids be deformed, for example, as a result of weight displacement. As a result of the deformation, the lid is no longer sealed tightly on the rim of the container so that air exchange can take place between the interior of the container and the atmosphere. The compositions dry out and become encrusted as a result of this air exchange. This leads to inhomogeneities when the components of the putty are subsequently intermixed, and these inhomogeneities cause flaws, such as blistering and yellowing, in the cured coating.

### SUMMARY OF THE INVENTION

It is therefore an object of the present invention to provide means and methods for maintaining the product properties of a putty during production and application thereof, and more particularly to improve metering of the individual components.

This object is achieved in accordance with the invention by a container system comprising one or more cylindrical hollow bodies comprising a removable base plate and a removable lid, and by the use of the container system to produce curable putties, and by a method for the production of putties using the container system. Additional embodiments are disclosed in the description.

The container system of the invention comprises one or more cylindrical hollow bodies, each comprising a removable base plate and a removable lid or two removable lids located opposite to each other. The containers are intended to accommodate the individual components of a putty so that these components can be separately stored and transported. Suitable materials for the manufacture of the containers are metals such as sheet steel, plastics materials such as polyethylene, polypropylene, polyvinyl chloride, polystyrene, polyester, polycarbonate, polyamide, and dual-layer or multi-layer composites comprising at least two plastics materials. For the purposes of the invention, the containers are preferably made of metal. Furthermore, the containers can comprise a lining or coating on its internal surfaces in order to prevent reaction between the metal and the putty and to reduce the tendency of the composition to adhere to said internal surfaces. Coatings and films made of low-density polyethylene (LDPE) are very preferable, as they exhibit particularly low adhesion to putties based on epoxy resin and amines.

The container of the invention is a cylindrical hollow body. The base and top regions of this cylinder are each closed by a lid, or the base region is closed by a base plate and the top region by a lid. The lids and base plates are removably attached to the container wall forming the circumferential surface of the cylinder and they mostly have at least the same diameter as the circumference of the cylinder. The rims of the cylindrical hollow body are beaded. The lids and base plates comprise a circumferential camber at the edges thereof, and this camber at least partially encloses the beaded rim of the hollow body. The lid is configured such that it is sunk into the cylinder and placed on the cylinder such that its edge is located over the rim of the cylinder edge.

In a preferred embodiment of the present invention, the cambers in the lid and base plate, the beaded rim of the hollow body, or both, have a coating of sealant. Preferably, a plastic sealant having an adhesive effect is used. The sealant coating prevents leakage of the contents. At the same time, air is prevented from entering the container. Additionally, the lids or base plates resting on the beaded rim can be secured by means of a clamping ring. In order to prevent the container from opening accidentally, for example, as a result of expansion due to pressure during aviation transport, the lids and base plates are secured to the container by means of a clamping ring at the location of the beaded rim.

### BRIEF DESCRIPTION OF THE DRAWINGS

The sole FIGURE shows an embodiment of a container in accordance with the invention

### DETAILED DESCRIPTION OF PREFERRED EMBODIMENTS

The sole FIGURE shows, by way of example, an embodiment of a container (1) of the invention. The rims (2a) of the cylindrical hollow body or of the container wall (2) are beaded. For the purpose of closing the container, the lids and the base plates (3) are placed on the container rim (2a) in such a way that the circumferential camber disposed at the lid edge (3a) partially encloses the container rim (2a). The lid edge (3a) engages below the container rim (2a). A gasket or a sealing coating is provided at the lid edge such that it is located between the container rim (2a) and the lid edge (3a) when the container (2) is closed by the lid (3). The clamping ring (4) surrounds the lid edge (3a) and the container rim (2a). It secures the lid (3) on the container (2) and squeezes the gasket. The container (2) is thus hermetically sealed.

In a further preferred embodiment of the present invention, a plastic film is placed on the base plate of the container before the latter is filled, which plastic film is compatible with the compositions in the container. The film prevents the compositions from subsequently sticking to the base plate of the container. An additional film can be placed on the top surface of the putty before the container is closed by the lid. Furthermore, the plastic films placed between the contents and the lid or the base plate form an additional protection for the contents from drying out or becoming encrusted. For example, films made of polyethylene, polypropylene, polyvinyl chloride, polystyrene, polyester, polycarbonate, polyamide, or cellophane are suitable. Films of low-density polyethylene (LDPE) are very preferable, since they exhibit particularly low adhesion to putties based on epoxy resins and amines.

In a further preferred embodiment of the invention, the container system comprises at least two containers holding one component each, the proportion of these containers based on their filling volume corresponding to the volumetric mixing ratio of the two components. Thus, for example, for a two-component putty having a mixing ratio of 1:1 by volume, two equally large containers or two containers having the same filling volumes or holding capacities are used that are filled with the same volumes of the base component and the reactive component respectively. In order to achieve various outputs, the containers of the container system of the invention can be used in different sizes in terms of their contents. In this way, smaller quantities can also be mixed at constant mixing ratios.

The ease of removal of the contents from the containers of the invention and the almost complete availability of the contents thus achieved render the container system of the invention particularly suitable for use in the production of curable multi-component putties. The advantages of the container system of the invention become apparent particularly in the case of greatly differing mixing ratios of 2:1 or 3:1, by volume, for example. Usually, the components are intermixed in the predefined volumetric mixing ratio shortly before application of the putty. Hitherto, it has only been possible to partially remove the contents from the containers conventionally used, and the residual amounts remaining in the containers depended primarily on the size of the container. As a rule, the larger the internal area of the container, the greater the loss of material. It may be assumed that the residual amounts remaining in two equally large containers are the same, provided that proper care is taken when emptying the contents. That is, a mixing ratio of the components of 1:1, by volume, can be maintained without giving rise to any problems in the case of conventional containers. However, if a container two or three times larger is used for any one of the components, then the loss of material in the form of the residual amounts of the individual components remaining in the containers is clearly different. The mixing ratio is unintentionally altered, and this leads to deterioration of the product properties of the putty.

In order to produce the putty as proposed by the invention, the user removes the clamping ring and the lid, and optionally pulls the topmost film off from the putty. He then turns the container upside down so that it stands on the mortar board with its top facing downwardly. The user then removes the second clamping ring and the base plate or the second lid that is now located at the top. With the removal of this lid, the contents readily slump down on to the mortar board due to the lack of negative pressure. Due to the films placed in the container, no residues stick to the lid or the base plate of the container. To assist the process, the user can push the putty down with one hand while pulling the container up with the other. This procedure causes the contents of the container to move onto the mortar board in a simple manner. At the same time, the container is emptied almost entirely. The empty container is thus fit for recycling. The procedure can be repeated on the container containing the second component. In this way, the putty can be produced without great effort by mixing the base component and the reactive component in the correct mixing ratio followed by application thereof.

The individual containers of the container system of the invention can be emptied almost completely in a simple manner. There is no need for manually scraping out the container using a putty knife, this being a time-consuming and expensive process. At the same time, the required mixing ratio can be maintained as a result of substantially complete removal of the respective components from their containers.

What is claimed is:

1. A container system for pasty compositions comprising one or more cylindrical hollow bodies comprising a removable base plate and a removable lid.

2. The container system as defined in claim 1, wherein the rims of the hollow body are beaded.

3. The container system as defined in claim 1, wherein said base plate and said lid have a camber extending around the perimeter thereof, which camber at least partially surrounds the beaded rim of said hollow body.

4. The container system as defined in claim 1, wherein said camber in said lid and/or in said base plate and/or said beaded rim of said hollow body display a coating of sealant.

5. The container system as defined in claim 1, wherein said lid resting on said beaded edge and/or said base plate are fixed in position by a clamping ring.

6. The container system as defined in claim 1, wherein an additional, freely disposed film is provided between the filled composition and the base plate and/or lid.

7. The container system as defined in claim 1, wherein the system includes two containers, one container being provided for holding a first component and one container for holding a second component.

8. The container system as defined in claim 7, wherein the ratio of the dimensions of said two containers in terms of their capacity or their volume is equal to the ratio by weight or by volume of the two components.

9. A method for the production of curable putties from at least one base component and at least one reactive component using a container system as defined in claim 1 comprising the following steps:
(a) the base component is removed from a first container, to which end the lid is first removed, the container is placed upside down on a surface, following which the base plate is removed and the hollow body is raised so that its contents are substantially totally transferred from said hollow body to said surface
(b) the reactive component is removed from a second container, to which end the lid is first removed, the container is then placed upside down on said surface, the base plate is then removed and the hollow body is raised so that its contents are substantially totally transferred from said hollow body to said surface, and
(c) the two components are intermixed.

10. A curable putty produced by the method according to claim 9.
